(19) United States
(12) Patent Application Publication
(10) Pub. No.: US 2015/0152814 A1
(43) Pub. Date: Jun. 4, 2015

(54) RELIEF VALVE FOR ENGINE WITH TURBOCHARGER

(71) Applicant: Yoshinori Ito, Tokyo (JP)

(72) Inventor: Yoshinori Ito, Tokyo (JP)

(73) Assignee: MITSUBISHI ELECTRIC CORPORATION, Tokyo (JP)

(21) Appl. No.: 14/398,883

(22) PCT Filed: Jul. 26, 2012
(86) PCT No.: PCT/JP2012/068978

§ 371 Date: Nov. 4, 2014

(51) Int. Cl. F02M 25/07; F02B 47/08

(52) U.S. Cl. CPC F02M 25/072; F02B 47/08

(57) ABSTRACT

When a cover 18 closes an opening end surface 11d of a boss 11, an annular piece 18a moves close to an annular groove 20 to form a labyrinth structure, and thus a flow path for turbocharged air becomes narrower to produce air resistance, which causes the cover 18 to be hardly closed. Thus, chattering is prevented from occurring, and a relief valve 10 can be prevented from being damaged.

### TECHNICAL FIELD

The present invention relates to a relief valve provided in an intake system of an engine with a turbocharger.

### BACKGROUND ART

FIG. 7 is a schematic view of a configuration of an engine 2 with a turbocharger 1. As shown in FIG. 7, a throttle valve 4 of an intake path 3 is opened in an accelerator ON state, and air (hereinafter referred to as turbocharged air) compressed by a compressor 1a of the turbocharger 1 flows in an intercooler 5 to be carried to the engine 2. A turbine 1b is coaxially mounted to the compressor 1a, and when exhaust gas from the engine 2 flows in a discharge path 6 and rotates the turbine 1b, the compressor 1a also rotates. In addition, a wastegate valve 7 that adjusts the pressure of the exhaust gas is installed in the discharge path 6.

In an accelerator OFF state, the throttle valve 4 is closed, and thus the turbocharged air accumulates in the intake path 3. The turbocharged air thus accumulated leads to a damage to piping and the like of the turbocharger 1, the engine 2, and the intake path 3; on this account, upstream and downstream sides of the compressor 1a are connected through an air bypass path 8. When an air bypass valve 9 is opened, the turbocharged air is released to the upstream side from the downstream side of the compressor 1a.

Generally, in such a system, when the air bypass valve 9 is damaged for some cause while the engine 2 is operating, a relief valve 10 provided on the upstream side of the throttle valve 4 in the intake path 3 is opened in order to release the turbocharged air accumulated in the intake path 3 (see, for example, Patent Document 1).

FIGS. 8 and 9 are sectional views showing an example of the conventional relief valve 10, and respectively show a valve opened state and a valve closed state. The relief valve 10 is a pneumatic valve that is opened and closed by an action of an internal pressure in the intake path 3. A substantially tubular boss 11 has a male screw section 11a on an outer circumference surface thereof and is attached to the piping of the intake path 3. In addition, a valve abutting section 11b in a step form and a support press fit section 11c are formed inside the boss 11.

With a valve 13 and a washer 12 fixed on one end side of a rod 14, it is inserted into the boss 11 to make the valve 13 abut against the valve abutting section 11b. In addition, a spring 15 that biases the valve 13 in a valve closing direction and a bush 16 that pivotally supports the rod 14 in a slidable manner in the upper and lower directions are mounted to the rod 14. Further, a support 17 is press fit to the support press fit section 11c, and the bush 16 is caulked in a center hole of the support 17; thus, the inner components are fixed. Then, a cover 18 and a washer 19 are fixed to the other end side of the rod 14. An annular piece 18a continues from an outer circumference edge of the cover 18 to be externally fit on an opening end surface 11d of the boss 11, whereby foreign objects, water, and the like are prevented from entering a gap between the opening end surface 11d and the cover 18.

In the conventional relief valve 10, when abnormal rise in the pressure in the intake path 3 occurs, the pressure is applied to the valve 13; the valve 13 is separated from the valve abutting section 11b against the biasing force of the spring 15 to be in a valve opened state. On this occasion, the cover 18 integrated with the valve 13 through the rod 14 is separated from the opening end surface 11d of the boss 11. Thus, the turbocharged air accumulated in the intake path 3 is discharged outside through a gap between the valve 13 and the valve abutting section 11b, an opening section 17a of the support 17, and a gap between the cover 18 and the opening end surface 11d; as a result, the piping of the vehicle, the engine 2, and the like can be prevented from being damaged.

### PRIOR ART DOCUMENTS

### Patent Documents

Patent Document 1: Japanese Patent Application Laid-open No. H10-213245

### SUMMARY OF THE INVENTION

### Problems to be Solved by the Invention

The conventional relief valve 10 has the configuration described above; thus, when the valve is opened, the internal pressure in the intake path 3 becomes equal to the outside pressure, and the valve is closed by the biasing force of the spring 15. Therefore, there is a problem such that a cycle of the valve closing, the valve opening due to the abnormal rise in the internal pressure, and the valve closing is repeated to cause chattering, which damages the relief valve 10.

The present invention is made to solve the problem described above, and an object of the present invention is to provide a relief valve that prevents the chattering from occurring.

### Means for Solving the Problems

A relief valve for an engine with a turbocharger according to the present invention includes: a tubular member that communicates an intake path with the outside, and accommodates a valve element and a biasing member that biases the valve element in a valve closing direction thereinside; a cover that moves integrally with the valve element to open and close an opening end surface of the tubular member on the side of the outside; and a labyrinth structure formed in an opening/closing part between the opening end surface of the tubular member and the cover.

### EFFECT OF THE INVENTION

According to the present invention, the labyrinth structure is provided in the opening/closing part between the opening end surface of the tubular member and the cover, and thus air resistance is produced when the valve tries to close after once opened, so that the valve becomes hard to close. Thus, a relief valve that prevents chattering from occurring can be provided.

### BRIEF DESCRIPTION OF THE DRAWINGS

FIG. 1 is a vertical sectional view of a configuration of a relief valve according to Embodiment 1 of the present invention, and is in a valve opened state.

FIG. 2 is a vertical sectional view of the configuration of the relief valve according to Embodiment 1, and is in a valve closed state.

FIG. 3 is an enlarged view of an area A in FIG. 1.

FIG. 4 is a view of a part of a conventional relief valve corresponding to the area A.

FIG. 5 is an enlarged view of the area A showing a modification of a labyrinth structure of the relief valve according to Embodiment 1.

FIG. 6 is an enlarged view of the area A showing a modification of the labyrinth structure of the relief valve according to Embodiment 1.

FIG. 7 is a schematic view of a configuration of an engine with a turbocharger.

FIG. 8 is a vertical sectional view of a configuration of the conventional relief valve, and is in the valve closed state.

FIG. 9 is a vertical sectional view of the configuration of the conventional relief valve, and is in the valve opened state.

### BEST MODE FOR CARRYING OUT THE INVENTION

In the following, in order to describe the present invention in more detail, embodiments for carrying out the invention will be described with reference to the accompanying drawings.

### Embodiment 1

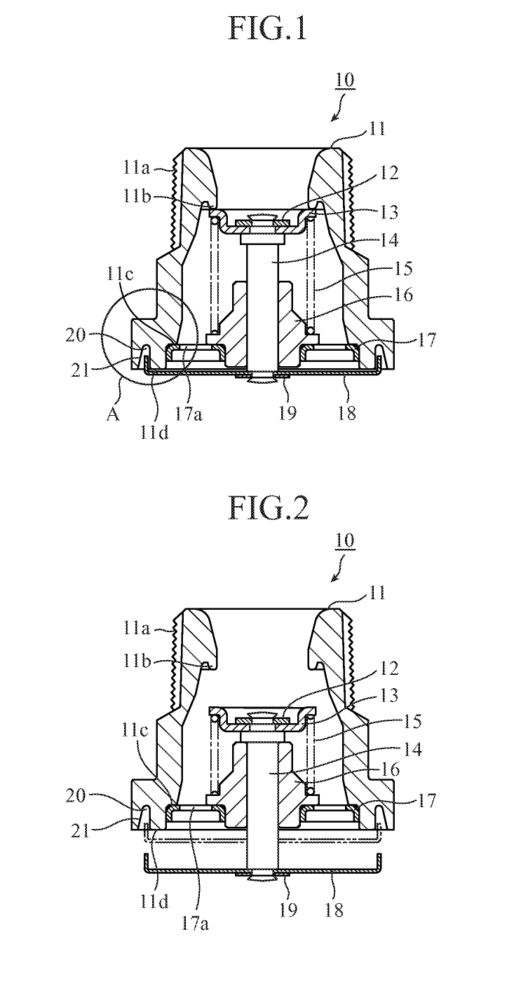

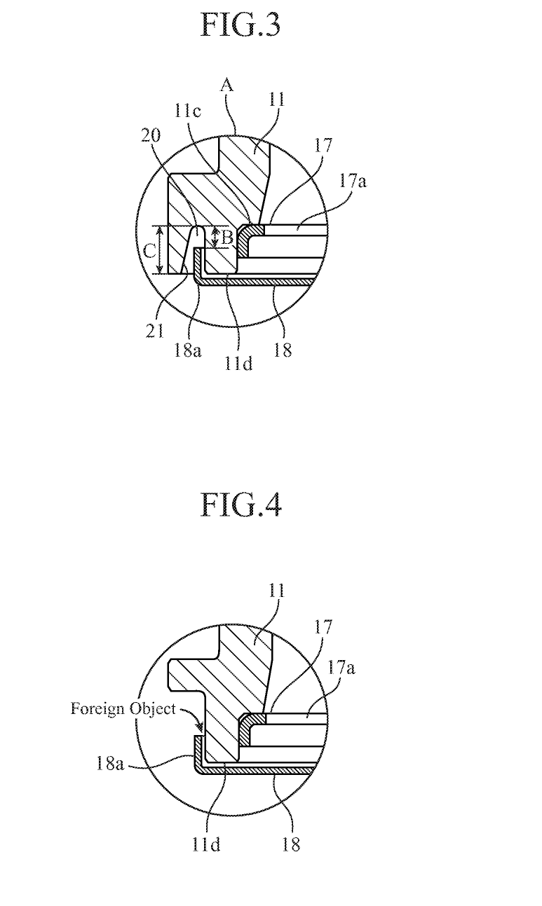

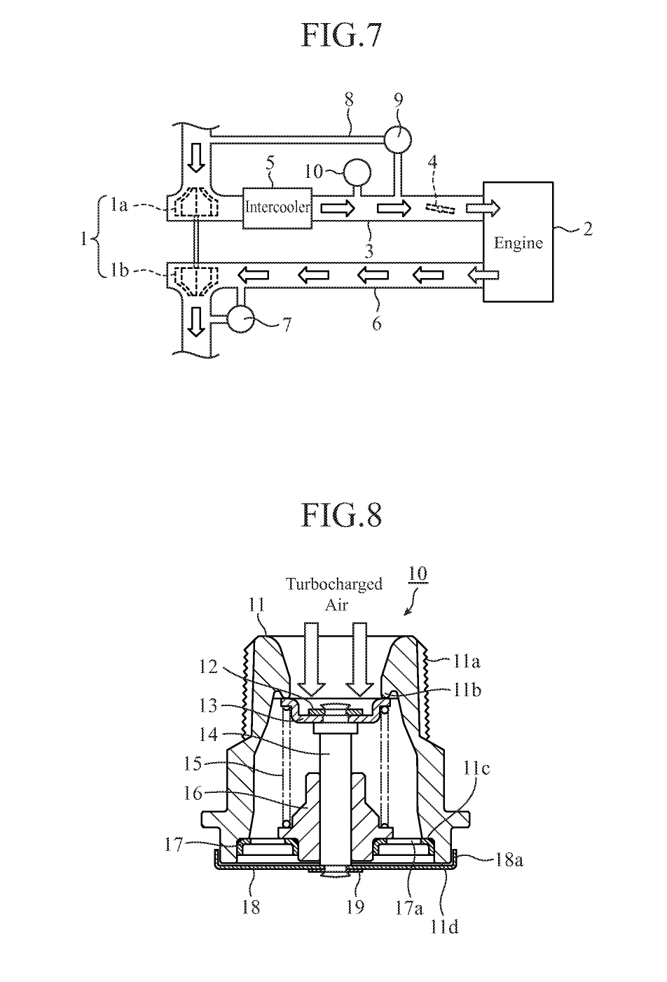

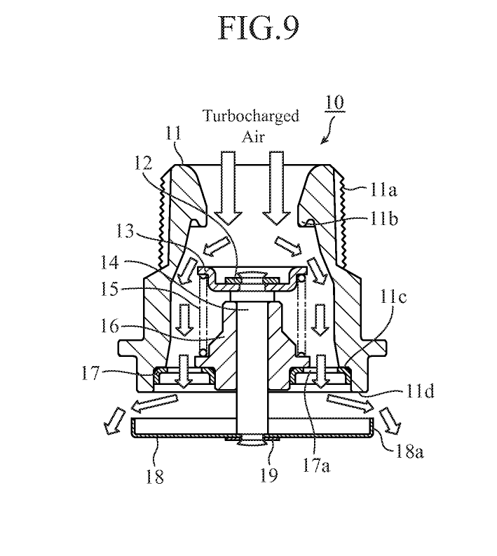

FIGS. 1 and 2 are vertical sectional views of a relief valve 10 according to Embodiment 1 in a valve closed state and a valve opened state, respectively. In addition, FIG. 3 is an enlarged view of an area A in FIG. 1. Note that in FIGS. 1 to 3, the same parts as or equivalent to those in FIGS. 8 and 9 are denoted with the same reference numerals, and explanations thereof will be omitted. The relief valve 10 according to Embodiment 1 shown in FIGS. 1 to 3 is attached to the intake path 3 in FIG. 7, as is the case with the conventional relief valve 10 shown in FIGS. 8 and 9.

In the relief valve 10 according to Embodiment 1, an annular groove 20 is formed at an opening end surface 11d on an outside communication side of a boss (cylindrical member) 11. In a state where the opening end surface 11d of the boss 11 is closed by a cover 18 as shown in FIG. 1, an annular piece 18a protruding from an outer circumference edge of the cover 18 fits in the annular groove 20. On this occasion, as shown in FIG. 3, a labyrinth structure is established in a clearance between the annular piece 18a and the annular groove 20.

When a pressure in the intake path 3 rises to a predetermined pressure or higher due to a failure of the air bypass valve 9 or other reasons, that pressure is applied to a valve (valve element) 13, so that the valve 13 is separated from a valve abutting section 11b against a biasing force from a spring (biasing member) 15 to be put in a valve opened state. At this time, as illustrated with a solid line in FIG. 2, the cover 18 is separated from the opening end surface 11d of the boss 11 to thus form a gap, and turbocharged air accumulated in the intake path 3 is thus discharged outside through the gap.

When the valve 13 is opened and the cover 18 is opened, the internal pressure in the intake path 3 becomes equal to the outside pressure, so that the pressure applied to the valve 13 drops; therefore, the valve 13 moves close to a side of the valve abutting section 11b by the biasing force from the spring 15, and approaches a valve closed state. At this time, as illustrated with two dot chain lines in FIG. 2, the annular piece 18a of the cover 18 moves close to the annular groove 20 of the boss 11 to thus establish the labyrinth structure, whereby a flow path for the turbocharged air becomes gradually narrower to produce air resistance, so that the cover 18 becomes hard to close. Thus, when abnormal rise of the internal pressure in the intake path 3 occurs, the relief valve 10 has a structure to be easily opened and hardly closed, thereby suppressing occurrence of chattering. Note that even when the relief valve 10 becomes hard to close, the travel of a vehicle is possible although an output of the engine 2 drops.

By contrast, the conventional relief valve 10 shown in FIGS. 8 and 9 has no labyrinth structure, and thus has the structure in which the valve is easily opened and closed when the abnormal rise in the internal pressure in the intake path 3 occurs. For this reason, the repetitive opening and closing may cause the chattering, which damages the relief valve 10.

In addition, when the conventional relief valve 10 shown in FIGS. 8 and 9 is installed facing downward such that the cover 18 opens downward as shown in the drawings, there is provided a structure in which a foreign object is easy to mix at a clearance section between the opening end surface 11d of the boss 11 and the annular piece 18a of the cover 18. In this connection, FIG. 4 is an enlarged view of a part corresponding to an area A in FIG. 1 in a case where the conventional relief valve 10 is installed facing downward. In this case, the clearance between the opening end surface 11d of the boss 11 and the annular piece 18a of the cover 18a is opened upward, and thus the foreign object is easy to enter at this clearance section.

Furthermore, in the conventional relief valve 10, when water attaches to the clearance section between the opening end surface 11d of the boss 11 and the annular piece 18a of the cover 18, the surface tension may prevent the water from dropping down. Generally, the boss 11 is made of aluminum, whereas the cover 18 is made of metal and plated, and is susceptible to corrosion. Because of this, when water attaches to the clearance section, the cover 18 may corrode, or may adhere to the boss 11 by freezing of the attached water. This may raise a possibility of hindering the valve opening.

Due to the reasons described above, it has been widely acknowledged that the relief valve 10 of the conventional configuration should preferably be installed facing upward with the cover 18 facing upward.

In view of this, as shown in FIG. 3, in the relief valve 10 according to Embodiment 1, the depth of the annular groove 20 is set such that when a size B represents a clearance between a bottom section of the annular groove 20 and a distal end section of the annular piece 18a and a size C represents the depth of the annular groove 20, then the labyrinth has a configuration satisfying: size B<size C. In the present structure, since the size C is greater than the size B, the foreign object is less likely to enter the clearance between the opening end surface 11d of the boss 11 and the annular piece 18a of the cover 18, thereby reducing the risk of intrusion of the foreign object. In this manner, the installation facing downward of the relief valve 10 becomes possible. Thus, the installation facing downward thereof becomes possible, in addition to the conventional installation facing upward; therefore, variations of the mounting angle of the relief valve 10 can be increased.

In addition, in the relief valve 10 according to Embodiment 1, a wall surface of the annular groove 20 facing an outer surface side of the annular piece 18a is formed in a tapered shape 21, and thus the clearance between the wall surface and the outer surface of the annular piece 18a is configured to be narrower towards the bottom section of the annular groove 20. In this manner, the opening area on the outside communication side of the labyrinth structure is larger; even if water is attached thereto, it is more likely to drop down. Thus, the water is not likely to remain at the clearance section between the opening end surface 11d of the boss 11 and the annular piece 18a of the cover 18, whereby prevention of the corrosion and prevention of the adhering due to the freezing become possible.

As described above, according to Embodiment 1, the relief valve 10 is configured to include: the boss 11 that communicates the intake path 3 with the outside, and accommodates the valve 13 and the spring 15 that biases the valve 13 in the valve closing direction thereinside; the cover 18 that moves integrally with the valve 13 to open and close the opening end surface 11d of the boss 11 on the side communicating with the outside; and the labyrinth structure formed in the opening/closing part between the opening end surface 11d of the boss 11 and the cover 18. For this reason, when the valve 13 tries to close after once opened, the air resistance is produced in the labyrinth structure, so that the cover 18 becomes hard to close, and thus the valve 13 also becomes hard to close. Because of this, the chattering can be prevented from occurring, and the relief valve 10 can be prevented from being damaged. In addition, when the labyrinth structure is provided, the clearance section between the opening end surface 11d of the boss 11 and the annular piece 18a of the cover 18 is covered, and thus the intrusion of the foreign object to the clearance section can be prevented when the cover 18 is installed facing downward. Thus, variations of the mounting angle of the relief valve 10 can be increased.

Further, according to Embodiment 1, the labyrinth structure of the relief valve 10 is established by the clearance between the annular groove 20 formed at the opening end surface 11d of the boss 11, and the annular piece 18a protruding from the outer circumference edge of the cover 18 and fitted into the annular groove 20 in a state where the cover 18 is closed, and configured such that the wall surface of the annular groove 20 facing the outer surface side of the annular piece 18a has the tapered shape 21 in which the clearance between the wall surface and the outer surface of the annular piece 18a becomes narrower towards the bottom section of the annular groove 20. For this reason, the water attached to the clearance section between the opening end surface 11d of the boss 11 and the annular piece 18a of the cover 18 is more likely to drop down, whereby the prevention of the corrosion and the prevention of the adhesion due to the freezing become possible.

Furthermore, according to Embodiment 1, the labyrinth structure of the relief valve 10 has the following configuration: in a state where the cover 18 is closed, the size C of the depth of the annular groove 20 is larger than the size B of the clearance from the bottom section of the annular groove 20 to the distal end section of the annular piece 18a. For this reason, the risk of the intrusion of the foreign objects to the clearance section between the opening end surface 11d of the boss 11 and the annular piece 18a of the cover 18 can be further reduced.

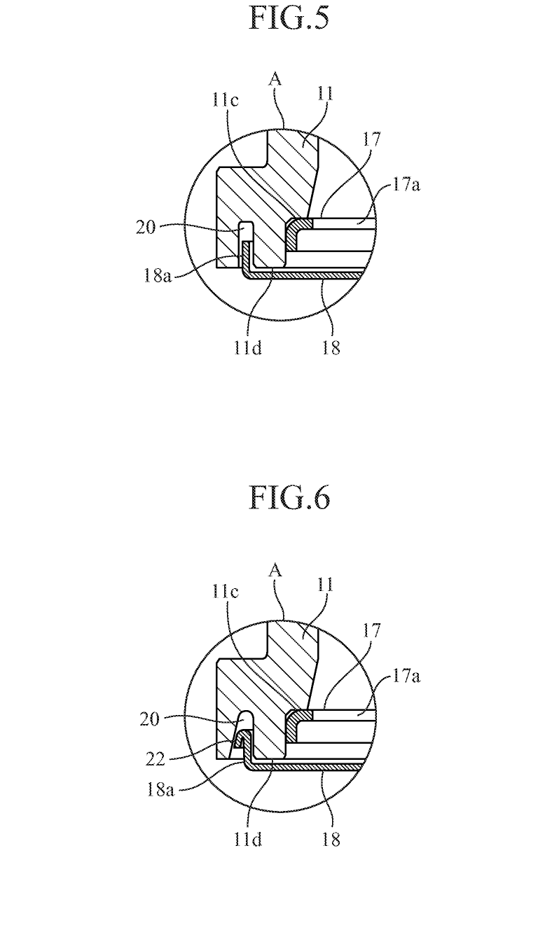

Additionally, the labyrinth structure is not limited to the configuration shown in FIGS. 1 to 3. Modifications of the labyrinth structure will be described below by referring to FIGS. 5 and 6.

FIG. 5 is an enlarged view of the area A, showing a modification of the labyrinth structure of the relief valve 10 according to Embodiment 1. In this modification, the wall surface of the annular groove 20 is formed to be parallel with the annular piece 18a, not adapted to have the tapered shape 21. Also in the case of this modification, the air resistance is produced with the labyrinth structure when the cover 18 is closed, which provides a structure in which the valve hardly closes, thereby preventing the chattering. Moreover, the relief valve 10 can be installed facing downward, because the foreign object can be prevented from entering the clearance between the opening end surface 11d of the boss 11 and the annular piece 18a of the cover 18.

FIG. 6 is an enlarged view of the area A, showing a modification of the labyrinth structure of the relief valve 10 according to Embodiment 1. In the labyrinth structure, not only the shape of the side of the boss 11 but also the shape of the side of the cover 18 may be modified. For example, the distal end section of the annular piece 18a is prepared with a bent section 22 having a shape bent outward. Also in the case of this modification, the air resistance is produced in the labyrinth structure, which provides a structure in which the valve hardly closes, thereby preventing the chattering. In addition, the relief valve 10 can be installed facing downward, because the foreign object can be prevented from entering the clearance between the opening end surface 11d of the boss 11 and the annular piece 18a of the cover 18. Furthermore, the wall surface of the annular groove 20 is formed to have the tapered shape 21 such that water is less likely to remain, whereby the prevention of the corrosion and the prevention of the adhesion due to the freezing are possible.

Further modification and omission can be made on the embodiment of the present invention as appropriate in a manner not described above, without departing from the scope of the invention.

### INDUSTRIAL APPLICABILITY

As described above, because the relief valve according to the present invention has the labyrinth structure in the opening/closing part between the cover and the boss to prevent the chattering, it is suitable for use in a relief valve that prevents abnormal rise of an internal pressure in an engine with a turbocharger, and so on.

### EXPLANATION OF REFERENCE NUMERALS

1: turbocharger
1a: compressor
1b: turbine
2: engine
3: intake path
4: throttle valve
5: intercooler
6: discharge path
7: wastegate valve
8: air bypass path
9: air bypass valve
10: relief valve
11: boss (cylindrical member)
11a: male screw section 11b: valve abutting section
11c: support press fit section
11d: opening end surface
12, 19: washer
13: valve (valve element)
14: rod
15: spring (biasing member)
16: bush
17: support
17a: opening section
18: cover
18a: annular piece
20: annular groove
21: tapered shape
22: bent section.

1. A relief valve for an engine with a turbocharger, which is installed in an intake path sending air compressed by a compressor of a turbocharger to an engine, and in which when a pressure of a fixed pressure or higher is applied to a valve element that is biased in a valve closing direction, the valve element is moved to discharge the air compressed by the compressor to the outside through the intake path,
the relief valve comprising:
a tubular member that communicates the intake path with the outside, and accommodates the valve element and a biasing member that biases the valve element in the valve closing direction thereinside;
a cover that moves integrally with the valve element to open and close an opening end surface of the tubular member communicating with the outside; and
a labyrinth structure formed in an opening/closing part between the opening end surface of the tubular member and the cover,
wherein the labyrinth structures is configured by a clearance between an annular groove formed at the opening end surface of the tubular member, and an annular piece protruding from an outer circumference edge of the cover and fitted into the annular groove in a state where the cover is closed.

2. The relief valve for an engine with a turbocharger according to claim 1, wherein
a wall surface of the annular groove facing an outer surface side of the annular piece has a tapered shape such that the clearance between the wall surface and the outer surface of the annular piece becomes narrower towards a bottom section of the annular groove.

3. The relief valve for an engine with a turbocharger according to claim 2, wherein in a state where the cover is closed, the labyrinth structure is such that a size of a depth of the annular groove is larger than a size of a clearance between the bottom section of the annular groove and a distal end section of the annular piece.
